(19) United States
(12) Patent Application Publication
(10) Pub. No.: US 2013/0282676 A1
(43) Pub. Date: Oct. 24, 2013

(54) GARBAGE COLLECTION-DRIVEN BLOCK THINNING

(71) Applicant: Quantum Corporation, San Jose, CA (US)

(72) Inventors: Gregory L. Wade, San Jose, CA (US); J. Mitchell Haile, Somerville, MA (US)

(21) Appl. No.: 13/918,624

(22) Filed: Jun. 14, 2013

Related U.S. Application Data
(63) Continuation-in-part of application No. 13/852,677, filed on Mar. 28, 2013.
(60) Provisional application No. 61/659,584, filed on Jun. 14, 2012.
(60) Provisional application No. 61/616,700, filed on Mar. 28, 2012.

(51) Int. Cl. G06F 17/30

(52) U.S. Cl. CPC G06F 17/30156
USPC 707/692

(57) ABSTRACT

An apparatus comprises one or more computer-readable storage media and program instructions stored on the one or more computer-readable storage media for facilitating garbage collection-driven volume thinning. The program instructions, when executed by a processing system, direct the processing system to at least generate deduplication data referenced to a plurality of files when deduplicating the plurality of files. The program instructions further direct the processing system to discover when the deduplication data has become unreferenced with respect to the plurality of files. Responsive to when the deduplication data has become unreferenced with respect to the plurality of files, the program instructions direct the processing system to initiate a thinning process with respect to a portion of a shared storage volume associated with the de-duplication data. The processing system is operatively coupled with the one or more computer-readable storage media and configured to execute the program instructions.

### RELATED APPLICATIONS

This application is a continuation-in-part of and claims priority to U.S. patent application Ser. No. 13/852,677 entitled “GARBAGE COLLECTION FOR VIRTUAL ENVIRONMENTS” filed on Mar. 28, 2013, which claims the benefit of and priority to U.S. Provisional Patent Application 61/616,700 entitled “DATA CONTROL SYSTEMS FOR VIRTUAL ENVIRONMENTS” filed on Mar. 28, 2012, both of which are hereby incorporated by reference in their entirety for all purposes. This application also claims the benefit of and priority to U.S. Provisional Patent Application No. 61/659,584 entitled “GARBAGE COLLECTION-DRIVEN BLOCK THINNING FOR A DATA STORAGE SYSTEM” filed on Jun. 14, 2012, which is hereby incorporated by reference in its entirety for all purposes.

### TECHNICAL FIELD

The present application relates to data deduplication, and in particular, to virtualized deduplication appliances and enhanced garbage collection processes.

### TECHNICAL BACKGROUND

Data deduplication is a specialized data storage reduction technique that eliminates duplicate copies of repeating data on a storage volume to improve storage utilization. In the deduplication process, data is analyzed to identify duplicative chunks of data and redundant chunks are replaced with a small reference that points to a single stored copy of the chunk. The data deduplication process typically inspects large volumes of data and identifies large sections, such as entire files or large sections of files that are identical, in order to store only one copy of it.

One type of data deduplication appliance contains dedicated storage devices that are used exclusively to store backup data and metadata managed by the appliance, such as hard disks or flash memory. In other data deduplication appliances, the storage devices may also be used for generic network storage in addition to backup storage.

Users of shared storage may be allocated a larger amount of storage space than is necessary for current demand. For example, users of the shared storage may have the ability to request as large a portion of the shared storage as they want. However, the storage does not actually become assigned to a particular user until the user writes data to the blocks. Once a block has become allocated to a particular user, the underlying shared storage may not be configured to reassign the block to another user, even if the block is no longer being used.

Some data deduplication appliances have been virtualized. In virtual machine environments, a hypervisor is employed to create and run a virtual machine. In particular, the hypervisor is typically implemented as computer software that executes on a host hardware system and creates a virtual system on which a guest operating system may execute. In a virtualized deduplication appliance, a hypervisor runs on a physical server that includes physical storage elements. While a single deduplication appliance may be implemented on the hypervisor, it is possible to implement multiple deduplication appliances on a single hypervisor. In such a situation, the underlying storage volume of the physical server can be considered a shared storage volume.

FIG. 1 is a block diagram that illustrates an operational scenario 100 in the prior art. FIG. 1 includes deduplication appliances 101, 151, and 161, hypervisor 110, and shared storage environment 171. Hypervisor 110 may comprise dedicated hardware, firmware, and/or software that could be implemented as a stand-alone application or integrated into a host operating system in some examples. Deduplication appliances 101, 155, and 165 run on the hypervisor. In this example, deduplication appliances 101, 151, and 161 are virtualized appliances, meaning they are implemented entirely as software executing on hypervisor 110 at the virtual layer. Each deduplication appliance 101, 151, and 161 utilize a portion of shared storage volume 177 of shared storage environment 171. Deduplication appliance 101 executes garbage collection process 105, while deduplication appliance 151 executes garbage collection process 155 and deduplication appliance 161 executes garbage collection process 165. Note that deduplication appliances 155 and 165 could include similar elements to those shown within deduplication appliance 101 but are not shown on FIG. 1 for clarity.

In data deduplication, even though a single file may appear to be stored multiple times in multiple locations on a storage volume, the file is actually stored once and the other file locations simply point to the same data that is associated with that single file. In fact, a single file is often stored across multiple data segments and a single data segment may be shared among multiple files. Thus, even identical segments of different files will not be duplicated in the storage volume. Deduplication thereby saves space in a storage volume by reducing unnecessary copies of data segments.

In this example, deduplication appliance 101 is shown as having files 111 and 121 both pointing to underlying deduplication data 131, and files 113 and 123 both pointing to underlying deduplication data 133. In operation, deduplication appliance 101 deduplicates files 111, 121, 113, and 123 and generates deduplication data 131 referenced to the files 111 and 121, and deduplication data 133 referenced to the files 113 and 123. Deduplication appliance 101 stores deduplication data 131 and deduplication data 133 on virtual storage volume 107. Deduplication appliance 101 records these deduplication data references to their corresponding files in deduplication index 103.

Once all pointers to deduplication data 131 have been deleted (i.e., both files 111 and 121 have been deleted and thus no longer point to deduplication data 131), deduplication data 131 has effectively been deleted, but still remains as “garbage” on the virtual storage volume 107. Deduplication appliance 101 thus executes a garbage collection process 105 to update its own metadata to signify that the data blocks which formerly made up deduplication data 131 on virtual storage volume 107 are now available.

In this prior art scenario, the garbage collection process 105 executed by deduplication appliance 101 is complete after changing the internal metadata to reflect that the data blocks associated with deduplication data 131 no longer contain data that is live (i.e., both files 111 and 121 have been deleted and thus no files now point to the deduplication data 131), and so these data blocks in virtual storage volume 107 are now reusable by deduplication appliance 101. However, while the deduplication metadata may be sufficient to indicate free blocks in virtual storage volume 107 for reuse by deduplication appliance 101, the metadata does not apply to any storage volumes that underlie virtual storage volume 107, such as shared storage volume 177.

### Overview

To facilitate block thinning, a garbage collection process is executed for a virtual storage volume to discover unreferenced data in a data set. In response to discovering the unreferenced data, the virtual block(s) in which this unreferenced data are stored are identified. In addition to performing a garbage collection function, the garbage collection process may also initiate thinning with respect to an underlying shared storage volume that physically stores the virtual blocks. As data blocks in the virtual storage volume are released to a block pool for allocation by way of the garbage collection process, their corresponding blocks in the underlying physical storage volume can be released from their association with the virtual storage volume. This is accomplished by a thinning process, which may be invoked directly or indirectly by the garbage collection process. The thinning process works to thin a portion of the shared storage volume that corresponds to the portion of the virtual volume that is subject to the garbage collection process. Thus, portions of the shared storage volume that had been allocated to the virtual storage volume can be released for potential allocation to other virtual volumes associated with other deduplication appliances, virtual machines, or any other process or application that may utilize the shared storage volume.

### BRIEF DESCRIPTION OF THE DRAWINGS

FIG. 1 is a block diagram that illustrates an operational scenario in the prior art.

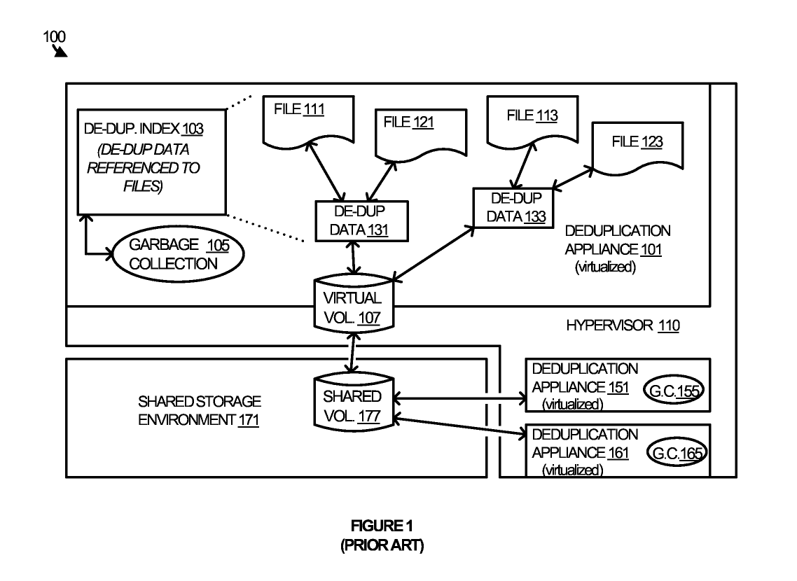

FIG. 2 is a block diagram that illustrates an operational scenario in an exemplary embodiment.

FIG. 3A is a block diagram that illustrates an operational scenario in an exemplary embodiment.

FIG. 3B is a block diagram that illustrates a thinning scenario in an exemplary embodiment.

FIG. 4 is a block diagram that illustrates an operational scenario in an exemplary embodiment.

FIG. 5 is a block diagram that illustrates an operational scenario in an exemplary embodiment.

FIG. 6 is a block diagram that illustrates an operational scenario in an exemplary embodiment.

FIG. 7 is a block diagram that illustrates a computing system in an exemplary embodiment.

### DETAILED DESCRIPTION

In various implementations and scenarios described herein, garbage collection processes running within the context of virtualized deduplication appliances can drive the thinning of shared storage volumes at a layer below that at which the deduplication appliances are virtualized. In this manner, shared storage can be more efficiently allocated to multiple virtualized deduplication appliances.

In at least one implementation, a hypervisor is implemented on a suitable computing system. Multiple deduplication appliances are running on the hypervisor and each is associated with its own virtual storage volume. The deduplication appliances generate deduplication data that is stored in their respective virtual storage volumes. As data is written to the virtual storage volumes, the data is pushed down to a shared storage environment at a layer below the hypervisor.

Over time, unreferenced data accumulates in the virtual storage volumes as files that had been deduplicated are deleted or are otherwise no longer subject to deduplication. As this occurs, garbage collection processes can be executed by the deduplication appliances to free the data blocks in their respective virtual storage volumes that are associated with the unreferenced data.

In addition, the garbage collection processes can initiate thinning processes such that portions of the shared storage volume associated with the unreferenced data can be thinned. In the aggregate, this enables improved allocation of the shared storage volume to the virtual storage volumes associated with the deduplication appliances. As an example, the garbage collection processes may issue trim commands with respect to either the shared storage volume, the virtual storage volumes, or both, that result in thinning of the shared storage volume. Other mechanisms for initiating thinning are possible and may be considered within the scope of the present disclosure.

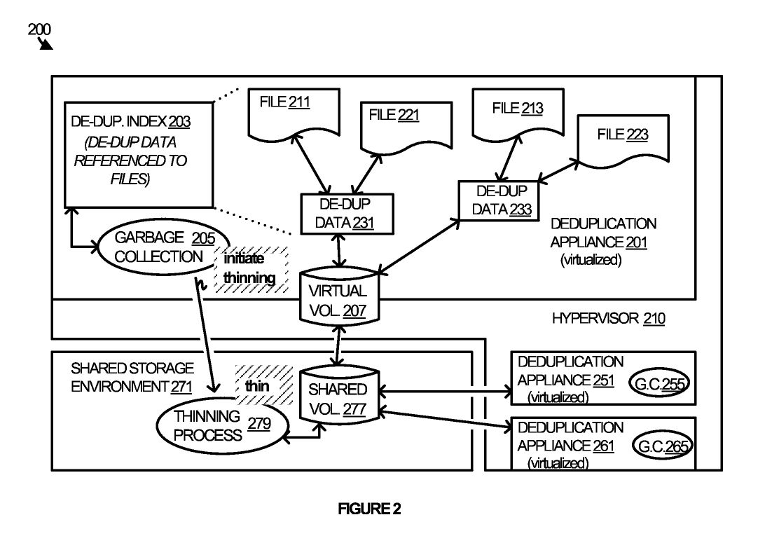

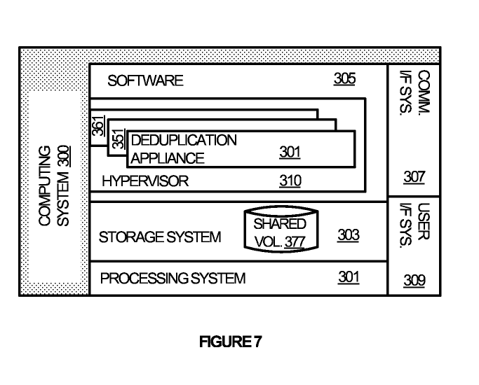

FIG. 2 is a block diagram that illustrates an operational scenario 200 in an exemplary embodiment. Operational scenario 200 may be carried out by a suitable computing system capable of implementing hypervisor 210 and shared storage environment 271, an example of which is discussed in more detail with respect to FIG. 7. In operation, a deduplication appliance 201 is implemented on hypervisor 210, along with multiple other deduplication appliances 251 and 261. The deduplication appliances 201, 251, and 261 are considered virtualized deduplication appliances because they are running on the hypervisor 251.

The deduplication appliances 201, 251, and 261, because they are implemented on the hypervisor 201, ultimately utilize shared storage environment 271. In particular, FIG. 2 illustrates deduplication appliance 201 in more detail to demonstrate how shared storage environment 271 is used.

Deduplication appliance 201 functions to deduplicate files, objects, or any other type of element or data item. In operational scenario 200, deduplication appliance 201 deduplicates file 211, file 221, file 213, and file 223. It is assumed for exemplary purposes that file 211 and file 221 are duplicates of each other. This may occur when, for example, two or more different users have the same file or set of files, as well as for any other reason. Deduplication appliance 201 generates deduplication data 231 to represent both file 211 and file 221. In this manner, the amount of storage needed to store file 211 and 221 separately is reduced by half since only deduplication data 231 need be stored. A similar deduplication process may occur with respect to file 213 and file 223 resulting in deduplication data 223.

Deduplication data 231 and deduplication data 233 are stored in virtual volume 207. Deduplication appliance 201 generates a deduplication index 203 that maps the relationship between files that are deduplicated and the corresponding deduplication data. In particular, deduplication data is represented in data blocks. Each data block in the deduplication index 203 is referenced to a given file that was deduplicated.

Over time, data blocks or deduplication data may become unreferenced. This occurs when, for example, files are deleted at a higher layer subject to deduplication such that their corresponding deduplication data is no longer needed. From the perspective of virtual volume 207, in which the deduplication data is stored, this creates waste and otherwise reduces the efficiency of read and write operations.

Garbage collection process 205 functions to improve the operation of virtual volume 207 by examining when the various data block identified in deduplication index 203 become unreferenced. As mentioned above, this may happen when, for example, the files from which deduplication data is generated are deleted. As the unreferenced blocks are discovered, garbage collection process 205 changes deduplication index 203 so that the associated data blocks can be used again. For example, the data blocks may be marked as unallocated or otherwise released to a pool of potential blocks for allocation to deduplication appliance 201.

In addition to performing a garbage collection function, garbage collection process 205 may also initiate thinning with respect to shared volume 277. As data blocks in virtual volume 207 are released to a block pool for allocation, their corresponding blocks in shared volume 277 can be released from their association with virtual volume 207. This is accomplished by thinning process 279, which is invoked directly or indirectly by garbage collection process 205. For example, garbage collection process 205 may communicate via an application programming interface (API) with thinning process 279. However, other elements within hypervisor 210 or deduplication appliance 201 may be capable of invoking thinning process 279.

Thinning process 279, upon being invoked, proceeds to thin a portion of shared volume 277 that corresponds to the portion of virtual volume 207 subject to garbage collection process 205. Thus, portions of shared volume 277 that had been allocated to virtual volume 207 can be released for potential allocation to other virtual volumes (not shown) associated with deduplication appliance 251 and deduplication appliance 261.

It may be appreciated that deduplication appliance 251 may include a garbage collection process 255 that functions in much the same way as garbage collection process 205. In other words, garbage collection process 255 may also invoke thinning process 279, but with respect to portions of shared volume 277 allocated to deduplication appliance 251. Likewise, deduplication appliance 261 may include a garbage collection process 265 that functions in much the same way as garbage collection process 205. Garbage collection process 265 may invoke thinning process 279, but with respect to portions of shared volume 277 allocated to deduplication appliance 261.

In the aggregate, the implementation of such an enhanced garbage collection process may improve the efficiency with which data is stored in shared volume 277. Namely, portions of shared volume 277 that had been allocated to one virtual volume, but that are subsequently unneeded as identified by a garbage collection process, can be released to other volumes. For example, portions of shared volume 277 associated with portions of virtual volume 207 identified by garbage collection process 205 as no longer referenced to a file can be released to deduplication appliance 251 or 261, and so on with respect to garbage collection processes 255 and 265.

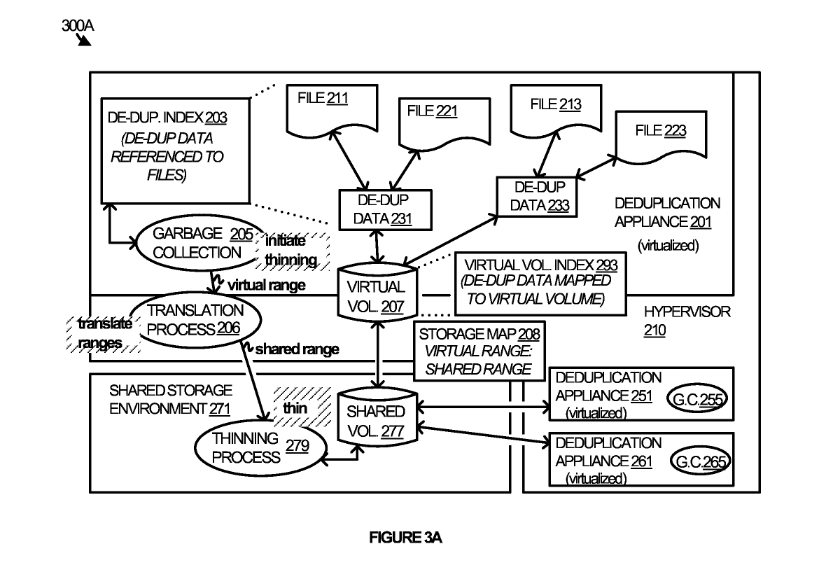

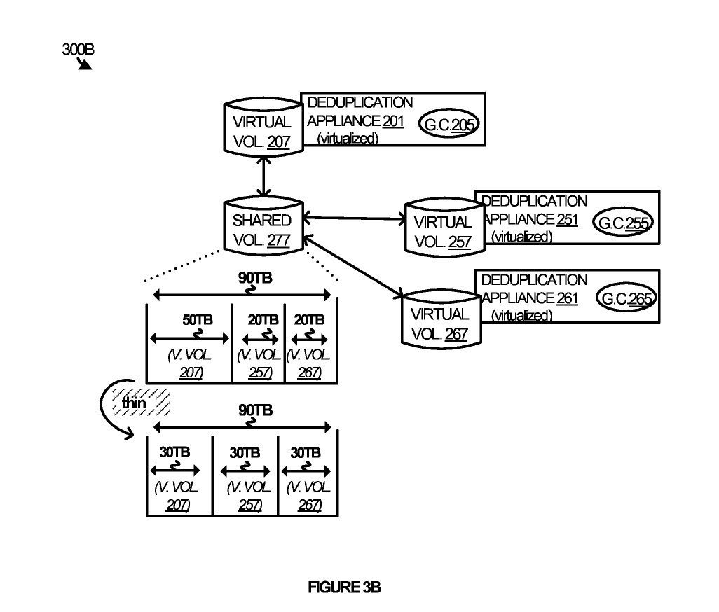

Referring now to FIG. 3A, another operational scenario 300A is illustrated. In operation, garbage collection process 205 examines when the data elements (deduplication data 231 and deduplication data 233) in deduplication index 203 become unreferenced. This may happen, for example, upon deletion of the files from which deduplication data 231 and deduplication data 233 are generated.

As the unreferenced deduplication data are discovered, garbage collection process 205 examines virtual volume index 293 to identify which data blocks in virtual volume 207 are associated with the unreferenced deduplication data. Garbage collection process 205 can then communicate with a virtual storage system associated with virtual volume 207 to release or otherwise free those data blocks for later allocation. The data blocks may be allocated later to other deduplication data that, for example, may be generated when other files are deduplicated.

Garbage collection process 205 then initiates thinning with respect to shared volume 277. As data blocks in virtual volume 207 are released to a block pool for allocation, their corresponding blocks in shared volume 277 can be released from their association with virtual volume 207. This is accomplished by thinning process 279, which is invoked directly or indirectly by garbage collection process 205. For example, garbage collection process 205 may communicate via an application programming interface (API) with thinning process 279. However, other elements within hypervisor 210 or deduplication appliance 201 may be capable of invoking thinning process 279.

In this scenario, garbage collection process 205 communicates a virtual range in virtual volume 207 identified for garbage collection. The virtual range identifies the virtual blocks in virtual volume 207 that were freed as a result of garbage collection process 205. Translation process 206 examines storage map 208 to translate the virtual range to a shared range in shared volume 277. The shared range in shared volume 277 is a range of blocks that correspond to the virtual range, as indicated by storage map 208.

Translation process 206 can then pass the shared range to thinning process 279. Thinning process 279, upon being invoked, proceeds to thin a portion of shared volume 277 that corresponds to shared range provided by translation process 206. It may be appreciated that translation process 206 may be implemented in hypervisor 210, but may also be implemented in deduplication appliance 201 or from within the context of some other application, program module, or the like, including from within shared storage environment 271.

FIG. 3B illustrates a thinning scenario 300B representative of how shared storage volume 277 may be thinned. For exemplary purposes, it is assumed that shared volume 277 has 90 terabytes of available storage. The 90 terabytes are allocated to virtual volume 207, virtual volume 257, and virtual volume 267. Depending upon the demands of each virtual volume, shared volume 277 may be allocated disproportionately at times. In this example, virtual volume 207 is allocated 50 terabytes, virtual volume 257 is allocated 20 terabytes, and virtual volume 267 is allocated 20 terabytes.

As discussed above, at least some of the storage in shared volume 277 allocated to virtual volume 207 be associated with unreferenced data and thus can be thinned. Upon a thinning process being initiated by any of garbage collection processes 305, 205, or 265, the available storage in shared volume 277 is reallocated to the various virtual volumes. In other words, storage that is not being used by one virtual volume, by virtue of the fact that the storage had been associated with unreferenced data blocks, can be allocated to other virtual volumes.

In this example, some of the 50 terabytes that had been allocated to virtual volume 207 are reallocated to virtual volume 257, associated with deduplication appliance 251, and virtual volume 267, associated with deduplication appliance 261. As a result, virtual volume 207 is allocated 30 terabytes, virtual volume 257 is allocated 30 terabytes, and virtual volume 267 is allocated 30 terabytes. It may be appreciated that the various storage amounts described herein are provided merely for illustrative purposes and are not intended to limit the scope of the present disclosure.

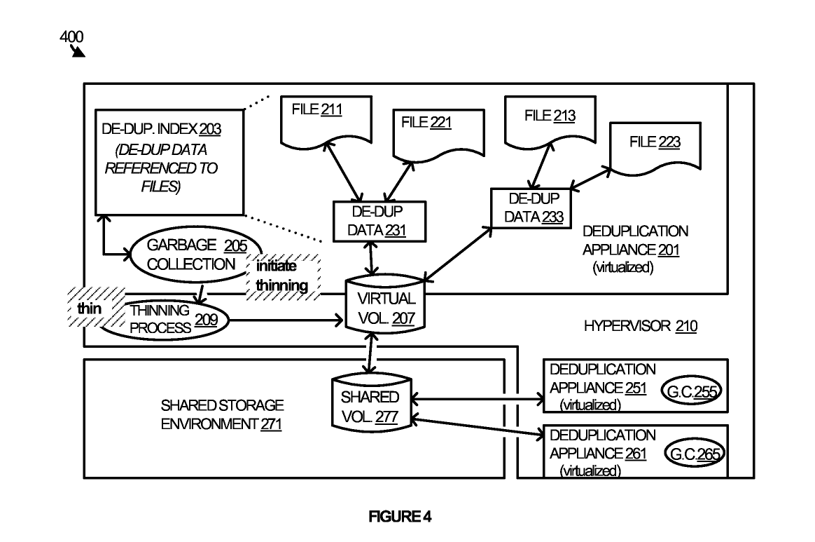

In FIG. 4, operational scenario 400 illustrates an implementation whereby garbage collection process 205 initiates a thinning process 209 that executes with respect to virtual volume 207 or an associated virtual storage element. This may occur when, for example, a virtual storage element subject to thinning is provided by hypervisor 210, such as a virtual solid state drive or any other storage element that can be thinned. In such a scenario, thinning process 209 may operate with respect to virtualized versions of the physical blocks that are associated with the logical blocks of virtual volume 207. However, in another example, virtual volume 207 may be shared with other appliance, applications, or other loads. In such a situation, virtual volume 207 may be logically allocated between the various loads, such as multiple deduplication appliances. In such a situation, thinning process 209 may operate with respect to how the logical blocks of virtual volume 207 are allocated to the various loads.

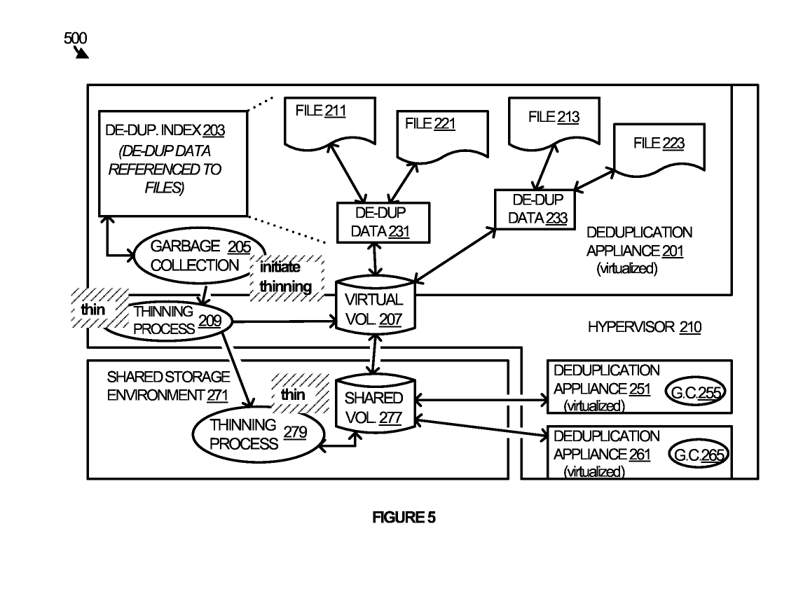

A variation of operational scenario 400 is provided in FIG. 5 whereby operational scenario 500 illustrates that a thinning process 279 may be triggered at the same time as or as a result of thinning process 209 executing. In this scenario, thinning process 209 is invoked by garbage collection process 205 to thin virtual volume 207 or an associated virtual storage element.

Garbage collection process 205 may issue a thinning command detected by hypervisor 201 that then launches thinning process 209. Thinning process 209 may itself issue another thinning command but with respect to thinning process 279. Alternatively, hypervisor 210 may issue the other thinning command or garbage collection process 205 may itself issue the other thinning command. Regardless, thinning process 279 is executed in shared storage environment 271 to thin the portion of shared volume 277 associated with those portions of virtual volume 207 either identified by garbage collection process 205 for reallocation or potentially targeted by thinning process 209.

It may be appreciate that the thinning command issued by garbage collection process 205 to invoke thinning process 209 may be intercepted by hypervisor 210 such that no thinning is performed with respect to virtual volume 207. However, it may also be the case that thinning is allowed to be performed with respect to virtual volume 207 or its associated virtual storage element.

In either case, the portion of virtual volume 207 or its associated virtual storage element to be thinned is translated to a corresponding portion of shared volume 277. The corresponding portion of shared volume 277 is communicated to thinning process 279, which can then thin shared volume 277.

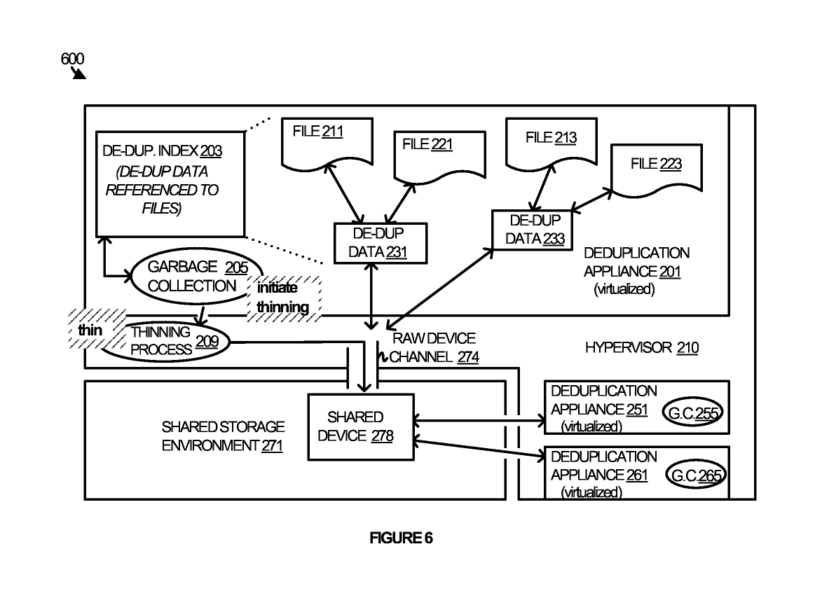

FIG. 6 illustrates operational scenario 600 that involves a raw device channel 274 through hypervisor 210 to shared device 278. Raw device channel 274 may be present when a hypervisor supports raw device mapping (RDM). This allows data to be written from applications supported by a hypervisor directly down to a shared physical device. Thus, in operational scenario 600, deduplication application 201 can write deduplication data 231 and deduplication data 233 directly to shared device 278 via raw device channel 274.

In scenario 600, garbage collection process 205 may identify data blocks that have become unreferenced with respect to any files, such as files 211, 221, 213, and 233. The data blocks can be free, unallocated, or otherwise returned to a pool of blocks for later allocation for deduplication purposes. Garbage collection process 205 may also invoke thinning process 209 to thin portions of shared device 278 corresponding to those data blocks. Garbage collection process 205 initiates thinning process 209 and identifies the data blocks to be thinned. Thinning process 209 communicates via raw device channel 274 through hypervisor 210 t0 shared device 278 to thin portions of shared device 278 corresponding to the unreferenced data blocks. Those corresponded portions of shared device 278 can thus be thinned and reassigned to other loads, such as deduplication application 251 and deduplication appliance 261.

FIG. 7 is a block diagram that illustrates computing system 300 in an exemplary embodiment. Computing system 300 is representative of an architecture that may be employed in any apparatus, system, or device, or collections thereof, to suitably implement all or portions of the techniques described herein and any variations thereof. In particular, computing system 300 could be used to implement garbage collection process 205, thinning process 209, thinning process 279, and/or translation process 206. These processes may be implemented on a single apparatus, system, or device or may be implemented in a distributed manner, and may be integrated within a virtualized deduplication appliance, but may also stand alone or be embodied in some other application in some examples.

Computing architecture 300 may be employed in, for example, desktop computers, laptop computers, tablet computers, notebook computers, mobile computing devices, cell phones, media devices, and gaming devices, as well as any other type of physical or virtual computing machine and any combination or variation thereof. Computing architecture 300 may also be employed in, for example, server computers, cloud computing platforms, data centers, any physical or virtual computing machine, and any variation or combination thereof.

Computing architecture 300 includes processing system 301, storage system 303, software 305, communication interface system 307, and user interface system 309. Processing system 301 is operatively coupled with storage system 303, communication interface system 307, and user interface system 309. Processing system 301 loads and executes software 305 from storage system 303. When executed by processing system 301, software 305 directs processing system 301 to operate as described herein for control process 200 or its variations. Computing architecture 300 may optionally include additional devices, features, or functionality not discussed here for purposes of brevity.

Referring still to FIG. 3, processing system 301 may comprise a microprocessor and other circuitry that retrieves and executes software 305 from storage system 303. Processing system 301 may be implemented within a single processing device but may also be distributed across multiple processing devices or sub-systems that cooperate in executing program instructions. Examples of processing system 301 include general purpose central processing units, application specific processors, and logic devices, as well as any other type of processing device, combinations, or variations thereof.

Storage system 303 may comprise any computer readable storage media readable by processing system 301 and capable of storing software 305. Storage system 303 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the storage media a propagated signal.

In addition to storage media, in some implementations storage system 303 may also include communication media over which software 305 may be communicated internally or externally. Storage system 303 may be implemented as a single storage device but may also be implemented across multiple storage devices or sub-systems co-located or distributed relative to each other. Storage system 303 may comprise additional elements, such as a controller, capable of communicating with processing system 301 or possibly other systems.

Software 305 may be implemented in program instructions and among other functions may, when executed by processing system 301, direct processing system 301 to operate as described herein for garbage collection process 205, thinning process 209, thinning process 279, and/or translation process 206. In particular, the program instructions may include various components or modules that cooperate or otherwise interact to carry out garbage collection process 205, thinning process 209, thinning process 279, and/or translation process 206. In this example, software 305 comprises hypervisor 310 that runs deduplication appliances 301, 351, and 361. The various components or modules may be embodied in compiled or interpreted instructions or in some other variation or combination of instructions. The various components or modules may be executed in a synchronous or asynchronous manner, in a serial manner or in parallel, in a single threaded environment or multi-threaded, or in accordance with any other suitable execution paradigm, variation, or combination thereof. Software 305 may include additional processes, programs, or components, such as operating system software or other application software. Software 305 may also comprise firmware or some other form of machine-readable processing instructions executable by processing system 301.

In general, software 305 may, when loaded into processing system 301 and executed, transform a suitable apparatus, system, or device employing computing architecture 300 overall from a general-purpose computing system into a special-purpose computing system customized to facilitate garbage collection-driven block thinning as described herein for each implementation. Indeed, encoding software 305 on storage system 303 may transform the physical structure of storage system 303. The specific transformation of the physical structure may depend on various factors in different implementations of this description. Examples of such factors may include, but are not limited, to the technology used to implement the storage media of storage system 303 and whether the computer-storage media are characterized as primary or secondary storage, as well as other factors.

For example, if the computer-storage media are implemented as semiconductor-based memory, software 305 may transform the physical state of the semiconductor memory when the program is encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate this discussion.

It should be understood that computing architecture 300 is generally intended to represent an architecture on which software 305 may be deployed and executed in order to implement the techniques described herein. However, computing architecture 300 may also be suitable for any computing system on which software 305 may be staged and from where software 305 may be distributed, transported, downloaded, or otherwise provided to yet another computing system for deployment and execution, or yet additional distribution.

Communication interface system 307 may include communication connections and devices that allow for communication with other computing systems (not shown) over a communication network or collection of networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned communication media, network, connections, and devices are well known and need not be discussed at length here.

User interface system 309 may include a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 309. In some cases, the input and output devices may be combined in a single device, such as a display capable of displaying images and receiving touch gestures. The aforementioned user input and output devices are well known in the art and need not be discussed at length here. User interface system 309 may also include associated user interface software executable by processing system 301 in support of the various user input and output devices discussed above. Separately or in conjunction with each other and other hardware and software elements, the user interface software and devices may support a graphical user interface, a natural user interface, or the like. User interface system 309 may be omitted in some examples.

In one operational example, a garbage collection process is executed to discover an unreferenced data block in a list of allocated blocks for a virtual disk file. A garbage collection process is commonly used to find and free unreferenced data blocks, which are no longer in use or referenced in the list of allocated blocks. The garbage collection process typically accesses the list of allocated blocks for the virtual disk file to identify unreferenced data blocks and alters metadata to mark at least one unreferenced data block that no longer contains live content and is thus reusable. In this manner, the garbage collection process effectively finds and frees these unreferenced data blocks from the allocated blocks list.

In response to discovering the unreferenced data block, a command is communicated to a file system to release the unreferenced data block. The command could be any message or instruction that indicates to the file system that the unreferenced data block no longer contains live data and can therefore be released. In some examples, the command to release the unreferenced data block comprises a TRIM command of the ATA command set. Additionally or alternatively, the command could comprise one or more explicit application programming interface (API) calls to release blocks, such as API calls provided by shared storage devices for this purpose. Other examples of the command to release the unreferenced data block are possible and within the scope of this disclosure.

Responsive to the command, the file system is configured to free at least one physical block in a data storage system corresponding to the unreferenced data block. By releasing the one or more physical blocks in the data storage system that correspond to unreferenced data blocks, these physical blocks are freed so that they can be used by other consumers, such as other guest operating systems, virtual machines, and any other systems, applications, or devices that are sharing the data storage system—including combinations thereof. For example, the data storage system could comprise shared storage for the virtual disk file associated with the list of allocated blocks and at least a second virtual disk file. In some examples, the data storage system itself could comprise a virtual disk, in which case the physical block being freed by the file system could comprise a virtual representation of a physical data block. In some examples, the file system could be configured to direct a hypervisor to release the at least one physical block in the data storage system corresponding to the unreferenced data block. In some examples, the garbage collection process could be invoked by a physical deduplication appliance and the data storage system could comprise a storage area network (SAN) that is shared with multiple computing systems. In other examples, a virtualized deduplication appliance running on a hypervisor could invoke the garbage collection process. Other examples and system architectures are possible and within the scope of this disclosure.

Advantageously, the command communicated to the file system during the garbage collection process allows for blocks of an underlying storage system to be freed as their corresponding blocks are being released from the allocated blocks list. In this manner, the blocks of the underlying storage system are freed so that they can be used by other consumers, instead of remaining reserved for but unused by the virtual machine associated with the virtual disk file. This operation thus enhances the typical garbage collection process by providing more optimal and efficient utilization of the underlying shared storage system.

The functional block diagrams, operational sequences, and flow diagrams provided in the Figures are representative of exemplary architectures, environments, and methodologies for performing novel aspects of the disclosure. While, for purposes of simplicity of explanation, methods included herein may be in the form of a functional diagram, operational sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The included descriptions and figures depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. An apparatus comprising:
one or more computer-readable storage media;
program instructions stored on the one or more computer-readable storage media for facilitating garbage collection-driven volume thinning that, when executed by a processing system, direct the processing system to at least:
when deduplicating a plurality of files, generate deduplication data referenced to the plurality of files;
discover when the deduplication data has become unreferenced with respect to the plurality of files; and
responsive to when the deduplication data has become unreferenced with respect to the plurality of files, initiate a thinning process with respect to a portion of a shared storage volume associated with the de-duplication data; and,
the processing system operatively coupled with the one or more computer-readable storage media and configured to execute the program instructions.

2. The apparatus of claim 1 wherein the program instructions further direct the processing system to, responsive to when the deduplication data has become unreferenced, identify the portion of the shared storage volume associated with the deduplication data.

3. The apparatus of claim 2 wherein, to identify the portion of the shared storage volume associated with the deduplication data, the program instructions direct the processing system to identify a portion of a virtual storage volume associated with the deduplication data and translate the portion of the virtual storage volume to the portion of the shared storage volume.

4. The apparatus of claim 3 wherein the program instructions further direct the processing system store the deduplication data in the virtual storage volume, wherein the shared storage volume is shared by a plurality of deduplication appliances, and wherein the shared storage volume includes the virtual storage volume.

5. The apparatus of claim 4 wherein to initiate the thinning process, the program instructions direct the processing system to issue a thinning command to a storage system associated with the shared storage volume to thin the portion of the shared storage volume associated with the deduplication data.

6. The apparatus of claim 5 wherein the thinning command comprises a trim command.

7. One or more computer-readable storage media having program instructions stored thereon for facilitating volume thinning that, when executed by a computing system, direct the computing system to at least:
identify data that has become unreferenced with respect to a plurality of files;
identify a portion of a virtual storage volume associated with the data;
identify a portion of a shared storage volume that corresponds to the portion of the virtual storage volume associated with the data; and
initiate a thinning process with respect to at least the portion of the shared storage volume that corresponds to the portion of the virtual storage volume associated with the data.

8. The one or more computer-readable storage media of claim 7 wherein the data comprises deduplication data generated while deduplicating the plurality of files.

9. The one or more computer-readable storage media of claim 8 wherein, to initiate the thinning process, the program instructions direct the computing system to issue a thinning command to a shared storage system associated with the shared storage volume.

10. The one or more computer-readable storage media of claim 9 wherein, to identify the data that has become unreferenced, the program instructions direct the computing system to perform a garbage collection process.

11. The one or more computer-readable storage media of claim 10 wherein the shared storage volume comprises a physical storage volume having a plurality of virtual machines stored thereon, wherein each virtual machine of the plurality of virtual machines comprises a virtualized deduplication appliance and wherein at least one of the plurality of virtual machines includes the virtual storage volume.

12. The one or more computer-readable storage media of claim 13 wherein the thinning command comprises a trim command.

13. A method for facilitating garbage collection-driven volume thinning comprising:
in a hypervisor, monitoring for a thinning command issued by a garbage collection process running in a deduplication appliance supported by the hypervisor;
in the hypervisor and responsive to detecting the thinning command issued by the garbage collection process, initiating a thinning process with respect to a portion of a shared storage volume shared with a plurality of deduplication appliances supported by the hypervisor.

14. The method of claim 13 wherein the shared storage volume comprises a plurality of virtual storage volumes associated with the plurality of deduplication appliances, wherein the plurality of deduplication appliances includes the deduplication appliance and wherein the deduplication appliance is associated with a storage volume of the plurality of storage volumes.

15. The method of claim 14 further comprising:
identifying deduplication data that has become unreferenced with respect to a plurality of deduplicated files;
identifying a portion of the virtual storage volume associated with the deduplication data; and
issuing the thinning command.

16. The method of claim 15 further comprising translating the portion of the shared storage volume associated with the deduplication data to the portion of the shared storage volume subject to the thinning process initiated by the hypervisor.

17. The method of claim 16 wherein the thinning command identifies at least the portion of the virtual storage volume associated with the deduplication data.

18. The method of claim 16 wherein the thinning command identifies at least the portion of the shared storage volume subject to the thinning process.

19. One or more computer-readable storage media having program instructions stored thereon for facilitating garbage collection-driven volume thinning that, when executed by a processing system, direct the processing system to at least:
generate deduplication data referenced to a plurality of files when deduplicating the plurality of files;
discover when the deduplication data has become unreferenced with respect to the plurality of files; and
responsive to when the deduplication has become unreferenced with respect to the plurality of files, initiate a thinning process with respect to a portion of a virtual storage volume associated with the deduplication data.

20. The one or more computer-readable storage media of claim 19 wherein the program instructions further direct the processing system to, responsive to when the deduplication data has become unreferenced with respect to the plurality of files, initiate a second thinning process with respect to a portion of a shared storage volume associated with the deduplication data.
